(19) United States
(12) Patent Application Publication
(10) Pub. No.: US 2005/0074311 A1
(43) Pub. Date: Apr. 7, 2005

(54) Large bale handler

(76) Inventor: Larry D. Byrd, Presho, SD (US)

Correspondence Address: Brinks Hofer Gilson & Lione;c/o Richard E. Stanley, Jr., NCB Tower, Suite 3600, P.O. Box 10395, Chicago, IL, 60610, US

(21) Appl. No.: 10/680,532

(22) Filed: Oct. 6, 2003

(51) Int. Cl. A01D 85/00

(52) U.S. Cl. 414/24.5

(57) ABSTRACT

A large bale handler is provided for transporting more than one large bale at a time. The bale handler includes tines that support the weight of at least two large bales. The tines extend along a length that is longer than one bale and supports the bales in tandem. Thus, two bales are loaded on the bale handler one behind the other.

### BACKGROUND

The present invention relates generally to agricultural equipment and particularly to a tractor implement for handling large bales.

Bale handlers are used throughout the agricultural industry for moving large bales from place to place. Large bales are typically made by baling machines that travel through a field and compact windrows of crop materials into a number of wrapped bales. Typical examples of the types of crop materials that are often baled include hay, straw, alfalfa, cane, cornstalks, millet and the like. Baling machines are available for making bales in a number of sizes and shapes, but bales are generally characterized as either small bales or large bales. The most typical small bale is rectangular in shape and usually weighs between 50 and 100 pounds. The small size of these bales makes it possible to move the bales by hand although some mechanized handlers are available that enable a number of small bales to be moved all at once. Large bales, however, are distinguished from small bales by their significantly larger size. Large bales are typically not intended to be moved by hand, and instead, are intended to be moved either singly or in small groups by mechanized equipment. Although large bales come in several shapes and sizes, the most common large bale is about 5.5 to 6 feet round and about 5 feet long (i.e., the bale is actually cylindrical in shape). These bales can vary significantly in weight depending on the type of crop material baled and the exact size of the bale. However, the typical weight of a large bale ranges between about 800 to 3,000 pounds. Another common large bale shape is rectangular. Large rectangular bales typically measure about 3 foot by 8 foot and weigh about the same as large round bales.

As explained above, large bales are intended to be moved by a bale handler. One common type of bale handler is a single bale fork. A single bale fork is typically connected to the rear of a tractor with the three-point hitch and has two parallel tines extending rearward. To use this type of single bale fork, the tines are lowered to the ground, and the tractor is backed up until the tines slide underneath the bale. The bale can then be raised by raising the three-point hitch of the tractor. The tractor then moves the bale to wherever the driver chooses. The bale is unloaded by lowering the bale fork again and driving the tractor forward.

As significant disadvantage of single bale forks is their inability to move more than one bale at a time. Usually ranchers and farmers must move many bales at a time and seldom does a rancher need to move only a single bale. One typical example in which many bales must be moved involves collecting bales from a harvested field. After cutting the crop material from a field, windrowing it and baling the crop material, the finished bales are typically scattered randomly throughout the field. The rancher or farmer must then pick up all of the bales in the field and move them to a place where the bales can be grouped and/or stacked together for storage. This can be a tedious process and requires numerous strips back and forth through the field to pick up and move all of the bales. Another typical example in which many bales must be moved involves feeding livestock. Generally, stacks of bales are stored at a location away from the livestock. Therefore, when the livestock need to be fed, the bales must be moved to where the livestock are located. In the case where a large number of livestock are being fed, numerous trips may be required to move all of the necessary bales to the livestock.

Another common type of bale handler is a side-by-side bale fork. This type of bale fork attempts to alleviate the problems of single bale forks by allowing two large bales to be moved at a time. This is accomplished by loading two large bales onto the bale fork side-by-side across the width of the tractor. Essentially, most side-by-side bale forks can be conceptualized as two single bale forks like that described above that are rigidly attached adjacent to each other. Thus, most side-by-side bale forks have four tines instead of two (i.e., two tines for each bale) that extend rearward about the same length as single bale fork tines.

Side-by-side bale forks, however, suffer from numerous problems. One problem is the overall width of the two bales after they are loaded onto the bale fork. Since large round bales are typically 5.5 to 6 feet in diameter (the bales also settle and become even wider after sitting for a long time), the overall width of two large bales on a side-by-side bale fork may be as wide as 12 to 13 feet. This creates major problems because the overall width of the two bales is wider than most gates and wider than most tractors. Thus, a side-by-side bale fork will not work when a rancher or farmer needs to pass through narrow and regular sized gates (which is especially common when feeding livestock). Moreover, even when there are no gates to pass through or the gates are unusually wide, the driver of the tractor must be particularly careful not to run into objects with the sides of the bales because the bales stick out wider than the tractor.

Another problem associated with the width of side-by-side bale forks is the tendency to twist and bend the bale fork during loading and unloading of the bales. Oftentimes, the ground surface that bales are loaded and unloaded from is not perfectly level. Because of the extra width of the bale fork, one of the sides can dig into the ground more than the other side when the tractor moves back towards a bale or forward away from a bale. When this occurs, the bale fork twists and frequently can be permanently bent.

Side-by-side bale forks can also be difficult and time-consuming to load. Typically, bales may be loaded onto a side-by-side bale fork in either of two ways. One way is to load each of the two bales separately. This can be difficult however because each of the bales must be loaded off-center from the tractor. This is harder than loading bales on center because the tractor driver may have a difficult time judging the correct amount of offset for each bale. Also, considering the fact that bales can become even wider than normal after sitting a while, the adjacent sides of the bales can hit against each other when the driver attempts to load the second bale. The other way of loading bales on a side-by-side bale fork attempts to avoid these problems by pre-positioning the bales. In this alternative loading scheme, the driver collects one bale using the front loader of the tractor or one side of the bale fork and carefully positions the bale next to another bale. Once positioned together, the driver can back up and slide the bale fork tines underneath both bales at the same time. This alternative however is time-consuming because it requires extra steps to load the bales.

Another problem with side-by-side bale forks is that the two bales have to be unloaded at the same time. When the three-point hitch of the tractor is lowered, both bales descend the same amount and contact the ground equally. Therefore, when the tractor is driven forward, both bales are pulled off the tines together. If the rancher or farmer wants to have the two bales located at different places, one of the bales has to be picked up again and moved to the other location. This adds an extra step which is time-consuming.

In view of these and other problems, there is a need for a large bale handler that can move more than one large bale at a time without the numerous problems associated with current bale handlers like side-by-side bale forks.

### SUMMARY

To solve the problems noted above and provide other advantages, a large bale handler is provided that may transport more than one large bale at a time. The bale handler includes tines that support the weight of at least two large bales. The tines extend along a length longer than one bale, thereby supporting the bales in tandem. That is, the two bales are loaded onto the bale handler one behind the other instead of side-by-side.

As will be appreciated, the bale handler may transport more bales than single bale forks (which can only transport one large bale at a time). The bale handler is also easier to use than side-by-side bale forks that transport two bales oriented side-by-side. One of the significant advantages of the bale handler is that it is narrower than side-by-side bale forks. Thus, the bale handler can pass easily through gates and minimizes the possibility of collisions between the sides of the bale fork and bales and various objects. The bale handler is also easy to load and unload. Additional details and advantages will become more apparent from the description below and the drawings.

### BRIEF DESCRIPTION OF SEVERAL VIEWS OF THE DRAWINGS

The invention may be more fully understood by reading the following description in conjunction with the drawings in which:

FIG. 1 is a rear perspective view of a bale handler connected to the rear of a tractor;

FIG. 2 is a side perspective view of the bale handler;

FIG. 3 is a side perspective view of the tractor connection of the bale handler;

FIG. 4 is a front perspective view of the tractor connection of the bale handler;

FIG. 5 is rear perspective view of the support beam of the bale handler;

FIG. 6 is a rear perspective view of a tractor with a loader on the front and the bale handler on the rear, showing a bale loaded on the loader and two bales loaded on the bale handler; and

FIG. 7 is a rear perspective view of a tractor with the bale handler, showing two bales loaded on the bale handler and the tractor passing through a gate.

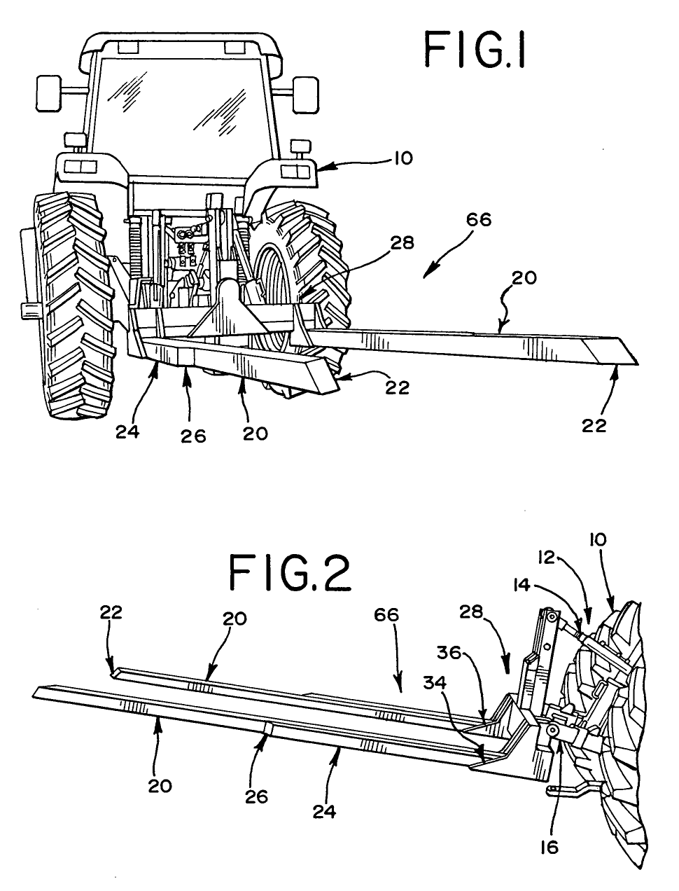

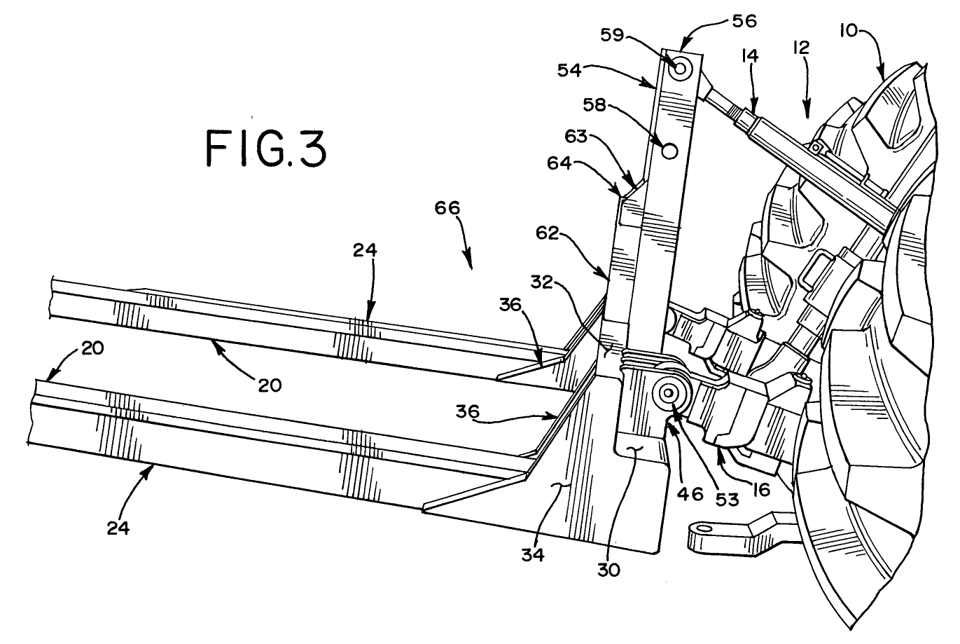

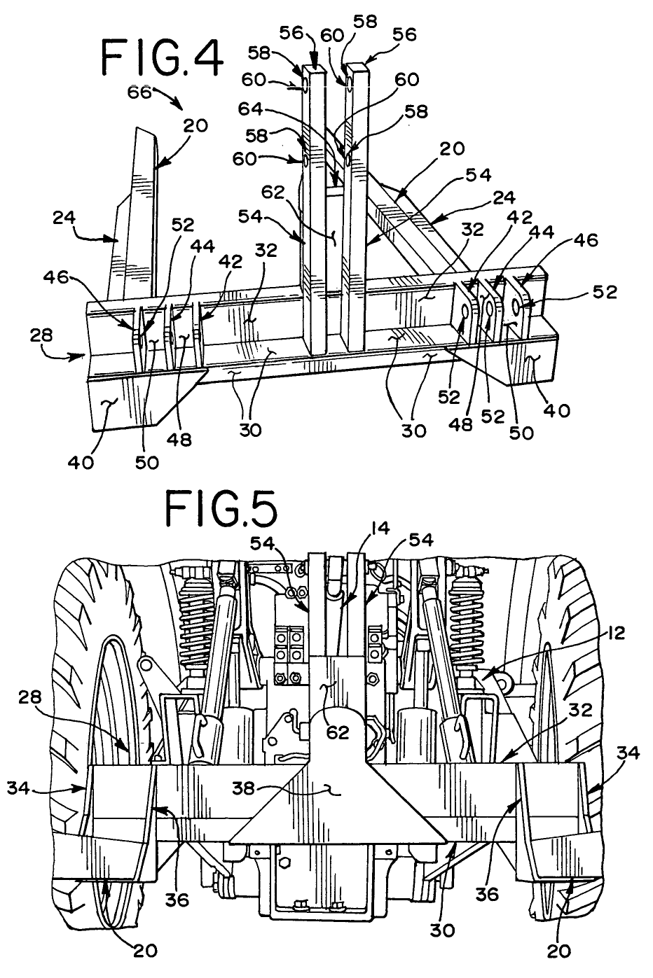

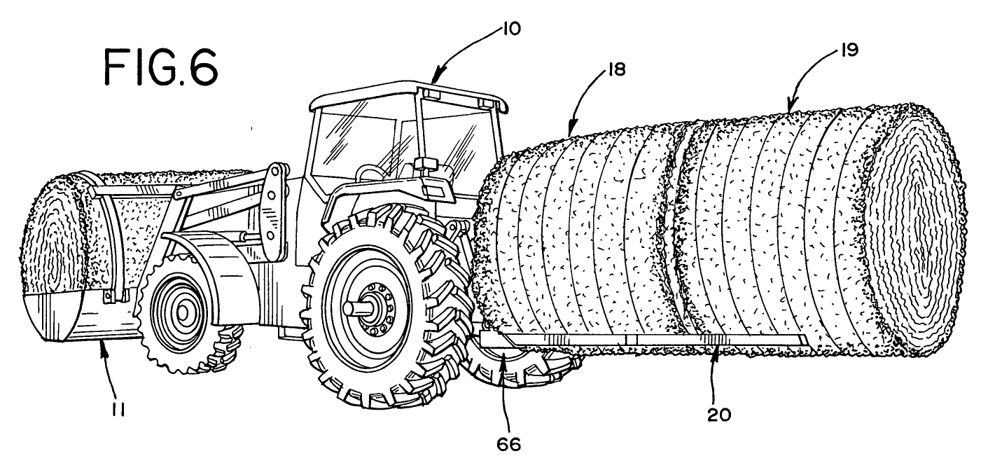

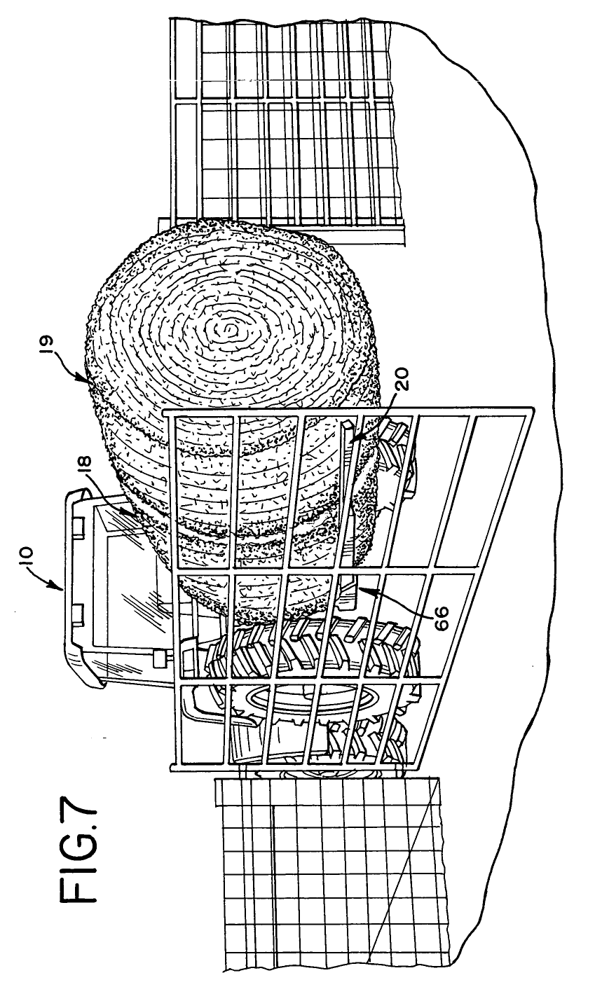

### DETAILED DESCRIPTION

Accordingly, a large bale handler is provided for moving two bales at the same time. The two large bales are loaded and supported by the bale handler in tandem (i.e., one bale behind the other). Thus, the width of the bale handler is approximately the width of a single large bale and the length is approximately the length of two large bales.

Turning now to the drawings, a bale fork 66 is shown connected to the three-point hitch 12 of a tractor 10 at the rear of the tractor 10. The bale fork 66 includes two main tines 20 that extend rearward from the tractor connection 28 of the bale fork 66 about 10 feet. The main tines 20 may be made from 4 in.×4 in.×5/16 in. steel tubing that is 132 inches long. The rearward ends of the main tines 20 are cut at a double angle and capped 22 with a diamond shaped 4.75 in.×7.75 in. steel plate that is 1/4 inch thick. The bale fork 66 also includes corresponding tine supports 24 that extend rearward from the tractor connection 28 along a portion of the main tines 20. The tine supports 24 may be made from 4 in.×2 in.×¼ in. steel tubing that is 69 inches long. The rearward end of the tine supports 24 is cut at an angle and capped 26 with a 4 in.×2 in. steel plate that is 1/4 inch thick.

The main tines 20 and tine supports 24 are rigidly attached to the tractor connection 28 with various welding in addition to outer side support plates 34 and inner side support plates 36. The outer side support plates 34 are welded to the outside of the tine supports 24 and the tractor connection 28 to provide rigid support between the tines 20, 24 and the tractor connection 28. The outer side support plates 34 may be made from 3/8 inch thick steel plate that is about 19 inches long at the bottom and cut to match the side profile of the tine supports 24 and the tractor attachment 28. The inner side support plates 36 are welded to the inside of the main tines 20 and the tractor attachment 28 to also provide rigid support between the tines 20, 24 and the tractor attachment 28. The inner side support plate 36 may be made from 3/8 inch thick steel plate that is about 19 inches long at the bottom and cut to match the side profile of the main tines 20 and the bottom and rear profiles of the tractor connection 28.

The tractor connection 28 includes a lower support beam 30 and an upper support beam 32 that both extend across the width of the bale fork 66 between the tines 20, 24. The lower support beam 30 may be made from 6 in.×3 in.×⅜ in. steel tubing that is 54 inches long. The upper support beam 32 may be made from 6 in.×2 in.×¼ in. steel tubing that is 54 inches long. A middle support plate 38 is provided along the rear of the tractor connection 28 to provide additional rigidity. The middle support plate 38 may be made from 1/4 inch thick steel plate that is about 20 inches long at the bottom and cut at an upwardly angled profile generally as shown. Front support plates 40 are provided along the front of the tractor connection 28 to provide both rigidity and to cap the front ends of the tines 20, 24. The front support plates 40 may be made from 1/2 inch thick steel plate that is about 6 inches long at the bottom and 12.5 inches long at the top.

The tractor connection 28 also includes inner connection plates 42, middle connection plates 44 and outer connection plates 46 for connecting to the lower arms 16 of the tractor three-point hitch 12. The connection plates 42, 44, 46 are welded to the lower support beam 30 and the upper support beam 32 and extend parallel to each other. The connection plates 42, 44, 46 may be made from 1/2 inch thick steel plate that is cut to match the profile of the lower and upper support beams 30, 32 and extend forward from the front edge of the lower support beam 30. Coaxial connecting holes 52 are also provided that extend through the connection plates 42, 44, 46, with the holes 52 through the outer and middle plates 46, 44 being 1.5 inches in diameter and the hole 52 through the inner plate 42 being 1 inch in diameter. Two spaces 48, 50 are formed between the connection plates 42, 44, 46. The first space 48 is formed between the inner plate 42 and the middle plate 44, and the second space 50 is formed between the middle plate 44 and the outer plate 46. The first and second spaces 48, 50 also extend downward below the bottom of the connection plates 42, 44, 46 along the front of the lower support beam 30. Accordingly, the first space 48 is adapted for category 2 hitch lower arms (not shown) and the second space 50 is adapted for category 3 hitch lower arms 16. To make it easier to change between category 2 and category 3 hitches, the connecting pin 53 is adapted to the connecting holes and may be stepped with a 1 inch diameter portion extending across the first space 48 and a 1.5 inch diameter portion extending across the second space 50. The space 48, 50 extending downward below the connection plates 42, 44, 46 is further adapted to allow a quick-attach hitch (not shown) to easily engage the connecting pins 53 from below.

The tractor connection 28 also includes connection beams 54 for connecting to the upper arm 14 of the tractor three-point hitch 12. The connection beams 54 extend upward and parallel to each other from the lower and upper support beams 30, 32. The connection beams 54 may be made from 4 in.×2 in.×¼ in. steel tubing that is 32 inches long. The connection beams 54 are capped 56 at the top end by 1.75 in.×3.75 in. steel plates that are 1/4 inch thick. Sets of coaxial connecting holes 58 that are 1.5 inches in diameter are provided which extend through the connection beams 54. The sets of connecting holes 58 may be provided at various heights along the connection beams 54 in order to accommodate different three-point hitches and tractors. To prevent water and debris from getting into the interior of the connection beams 54 and to provide a wear surface, bushings 60 are welded into the connecting holes 58. The connecting pin 59 is 1.5 inches in diameter and adapted to the connecting holes 58 and bushings 60. A connection beam support 62 is welded to the top of the upper support beam 32 and the rear of the connection beams 54 to provide rigid support for the connection beams 54. The connection beam support 62 may be made from 6 in.×2 in.×1/4 inch steel tubing that is 12 inches long. The connection beam support 62 is capped 64 at the top end by a 1.75 in.×5.75 in. steel plate that is 1/4 inch thick. Gussets 63 are also provided at the top of the connection beam support 62 to provide additional rigid support. The gussets 63 may be made from 1/4 inch thick steel plate that is about as wide as the connection beam support 62 and 4 inches high (cut at an angle). The gussets 63 are welded on the sides of the connection beam support 62 and the connection beams 54.

The steel members of the bale fork 66 are welded together throughout to form a rigid component. If the measurements described above are used, the total weight of the bale fork 66 is approximately 750 pounds. It should be recognized, however, that the construction details provided are exemplary only, and the bale fork 66 may be readily constructed with other dimensions, other materials, and/or other structures.

The advantages of the bale fork 66 are now readily apparent. One of the advantages is that the bale fork 66 can transport two bales 18, 19 at the same time. Thus, a rancher or farmer can significantly reduce the amount of time spent traveling when moving many large bales from one place to another. Accordingly, the bale fork 66 supports the weight of two large bales 18, 19 oriented in tandem, with one bale 18 in front of the other bale 19. In order to support two bales 18, 19 in tandem, the tines 20 are longer than single bale forks and side-by-side bale forks. Thus, in the described embodiment, the useable tine length extending rearward from the tractor connection 28 is 10.5 feet. Since large round bales are typically 5 feet long, this tine length extends the entire length of two large bales 18, 19 with about a ½ foot additional margin. However, other tine lengths may also be suitable to support two large bales in tandem. For example, a useable tine length more than 9 feet will in most cases sufficiently support the weight of two large bales in tandem. In addition, most single bale forks and side-by-side bale forks have useable tine lengths less than 6.5 feet. Therefore, a useable tine length more than 6.5 feet may be useful for supporting large bales in some applications.

One issue that user's of the bale fork 66 will need to address is weight balancing of the tractor 10. With single bale forks and side-by-side bale forks, weight balancing is usually not a significant concern because the bale(s) are positioned relatively close to the rear axle of the tractor 10. However, with the described bale fork 66, the rear bale 19 is positioned significantly farther away from rear axle of the tractor 10, thereby creating more leverage on the tractor 10 than other forks typically create. A number of weight balancing techniques may be used to address this issue. For example, tractors with a loader 11 installed on the front of the tractor 10 usually provide sufficient counter-weight due to the weight and placement of the empty loader to compensate for the additional leverage of the bale fork 66. If a loader 10 is not installed on the front of the tractor 10, the user may install balancing weights on the front of the tractor 10 instead. Moreover, in many cases if the tractor 10 has front wheel drive (as compared to a non-driving front axle), the additional weight of the front axle may be sufficient to compensate for the additional leverage of the bale fork 66. In any event, once properly balanced, a tractor 10 with about 100 h.p. should be sufficient to operate the bale fork 66 adequately.

One advantage of the bale fork 66 is that the overall width of the bale fork 66 is significantly narrower than the overall width of side-by-side bale forks. Whereas side-by-side bale forks are typically as wide as 12 to 13 feet measuring across the width of the bales, the described bale fork 66 is only half that width or less (i.e., the width of a single bale 18, 19 instead of two bales). This is a significant advantage because, instead of being wider than the width of the tractor 10 as with side-by-side bale forks, the described bale fork 66 is narrower than the width of the tractor 10. Thus, whereas with a side-by-side bale fork the driver is constantly concerned about hitting objects with the sides of the bale fork (and constantly looking rearward to avoid such collisions), the driver who uses the described bale fork 66 can safely pass by any object that clears the side of the tractor 10 without being concerned about the width of the bale fork 66. The narrower width of the bale fork 66 is especially advantageous when passing through gates. Most gates are not wide enough for a side-by-side bale fork that is loaded with two large bales to pass through. Even when a gate is unusually wide, the driver of a side-by-side bale fork must be particularly careful when passing through gates. In contrast, the described bale fork 66 easily passes through virtually any gate as long as the tractor 10 itself can pass though the gate. This allows ranchers and farmers to easily and efficiently move more large bales than is currently possible.

Another advantage of the bale fork 66 is that it is easier and faster to load and unload large bales 18, 19. One reason for this is that the bales 18, 19 are loaded on center instead of off-center as with side-by-side bale forks. Thus, the driver only needs to center the tractor 10 on the bales 18, 19 to be loaded and back up. In contrast, with side-by-side bale forks, the driver needs to guess about the right amount of offset that is needed for each of the bales. In addition, the driver of the described bale fork 66 does not need to engage in any extra steps to load the two bales 18, 19 like pre-positioning the two bales together as is often done with side-by-side bale forks. Instead, the driver of the described bale fork 66 simply backs up to one bale 18 to load the first bale 18 and then moves to another bale 19 and backs up again to load the second bale 19.

Loading bales 18, 19 onto the bale fork 66 is easier for other reasons also. One advantage of the bale fork 66 is the longer tine length compared to other bale handlers. With most bale handlers, the tines extend less than 6.5 feet rearward. Because of this short length, the driver must turn his head and look down to see the ends of the tines each time he loads a bale. This can become tedious, tiring and time-consuming when many bales need to be loaded and moved. However, with the described bale fork 66, the tines 20 extend further from the rear of the tractor 10, making it easier to see the ends 22 of the tines 20. Thus, in most cases the driver can see the ends 22 of the tines 20 simply by looking in the rearview mirror of the tractor 10 without having to turn his head. Therefore, this is another feature that helps make loading bales 18, 19 easier, faster and more comfortable.

One common problem of side-by-side bale forks is their tendency to dig into the ground surface and bend when loading bales onto the bale fork. This occurs because of the extra width of side-by-side bale forks which causes the outer corners to dig into the dirt when the ground surface is not level. When this happens, the bale fork may be permanently damaged, and the grass or other crop surface may also be damaged. The described bale fork 66 however does not suffer from this problem like wider bale forks. Instead, the described bale fork 66 is only as wide as necessary for one large bale 18, 19 instead of two large bales. Thus, in the described embodiment, the overall width across the tines 20, 24 is only 4.5 feet. This substantially eliminates the tendency to dig into uneven ground surfaces. Thus, the described bale fork 66 is much less susceptible to bending during bale loading or damaging the crop surface compared to wider bale forks like side-by-side bale forks. In addition, the described embodiment of the bale fork 66 raises the lower support beam 30 above the tines 20, 24. The advantage of this design is that only the bottoms of the tines 20, 24 contact the ground surface during loading, thereby further minimizing sliding friction between the bale fork 66 and the ground during loading and unloading.

Other advantages of the bale fork 66 include the smooth design of the tines 20, 24 which facilitates loading and unloading of the bales 18, 19. One aspect of this advantage is the diamond-shaped caps 22 at the end of the main tines 20 which face inward and upward. This shape for the main tine caps 22 allows the main tines 20 to slide smoothly beneath the bales 18, 19 without snagging on the twine that wraps around the bales 18, 19. In addition, the placement of the tine supports 24 along the sides of the main tines 20 further minimizes sliding friction both between the bale fork 66 and the ground and the bale fork 66 and the bales 18, 19. It is also important to not place the tine supports 24 on top of the main tines 20 because this would have the result of raising the first bale 18 by the height of the tine supports 24 compared to the second bale 19. As will be described below, this would interfere with easy unloading of the bales 18, 19.

Another advantage of the bale fork 66 is the ease and versatility with which the bales 18, 19 can be unloaded. Unlike side-by-side bale forks which require that the bales be unloaded together, the described bale fork 66 allows the two large bales 18, 19 to be unloaded at different locations. Accordingly, to unload the second bale 19 (i.e., the rearward most bale), the driver lowers the three-point hitch 12 of the tractor 10 until the ends 22 of the main tines 20 in addition to the bottom surface of the second bale 19 are in contact with the ground surface. The driver however does not lower the three-point hitch 12 all the way down in order to maintain a space between the bottom of the first bale 18 (i.e., the forward most bale) and the ground. Thus, as described at this stage, the tines 20, 24 will be angled downward from the tractor 10 toward the ground. In order to accomplish this angled orientation during unloading, the user may have to adjust the connection of the upper and lower arms 14, 16 of the three-point hitch 12. These adjustments however are well within the skill of ordinary ranchers and farmers. Once the three-point hitch 12 has been lowered as described, the driver simply drives the tractor 10 forward. Friction between the bottom of the second bale 19 and the ground then pulls the second bale 19 off the bale fork 66, and the bale 19 slides off onto the ground. The driver may then raise the three-point hitch 12 up again and drive to a new location to unload the first bale 18. Next, the first bale 18 is unloaded by lowering the three-point hitch 12 all the way down to the ground (i.e., in a float position which is available on most tractors 10). The bottom of the first bale 18 will now be contacting the ground surface, and the driver can unload the first bale 18 by simply driving forward again.

Other variations for unloading the two large bales 18, 19 are also possible. For example, the two bales 18, 19 may be unloaded next to each other but with a small gap between the bales 18, 19. This is an advantage for long-term storage of large bales 18, 19 because the gap between the bales 18, 19 prevents moisture buildup and ice formation between the bales 18, 19. Accordingly, both bales 18, 19 may be unloaded together with a small gap between the bales 18, 19 by lowering the three-point hitch 12 until the second bale 19 contacts the ground as previously described. The driver then drives forward to permit the second bale 19 to slide a short distance along the tines 20, 24. Once the two bales 18, 19 have separated the desired amount, the driver lowers the three-point hitch 12 all the way down so that both bales 18, 19 contact the ground. The driver then continues to drive forward while both bales 18, 19 slide off the bale fork 66 together. Likewise, the two bales 18, 19 may be unloaded together with no gap between the bales 18, 19. This is accomplished by simply lowering the three-point hitch 12 all the way so that the entire length of the tines 20, 24 is resting on the ground surface. The driver then drives forward and both bales 18, 19 slide off the bale fork 66 together due to friction with the ground. As described above, it is important that the tine supports 24 be on the side of the main tines 20 instead of on top of the main tines 20. If the tine supports 24 were placed on top of the main tines 20, the first bale 18 would be higher than the second bale 19 instead of at the same height. The difference in height between the two bales 18, 19 would then make it more difficult to precisely control the unloading of the two bales 18, 19 as described above.

While a preferred embodiment of the invention has been described, it should be understood that the invention is not so limited, and modifications may be made without departing from the invention. The scope of the invention is defined by the appended claims, and all devices that come within the meaning of the claims, either literally or by equivalence, are intended to be embraced therein.

1. A large bale handler, comprising: a tractor connection, and a tine attached to said tractor connection, said tine extending along a longitudinal axis of a tractor connected to said tractor connection, and said tine further extending along a length of two large bales thereby supporting a weight of said two bales and permitting said tractor to move said two bales from place to place.

2. The large bale handler according to claim 1, wherein said tine extends more than 6.5 feet from said tractor connection.

3. The large bale handler according to claim 1, wherein said tine extends at least 9 feet from said tractor connection.

4. The large bale handler according to claim 1, wherein said tine extends about 10 feet from said tractor connection.

5. The large bale handler according to claim 1, wherein each of said two large bales extends about 5 feet along said tine and each of said two large bales weighs about 1,000 pounds.

6. The large bale handler according to claim 1, wherein said tractor connection comprises three connection points adapted to be connected to a three-point hitch on a rear of said tractor, and further comprising at least two of said tines.

7. The large bale handler according to claim 1, wherein said tine is attached to a bottom of said tractor connection, each of said two large bales thereby being loadable by sliding said tine below each of said two large bales along a ground surface.

8. The large bale handler according to claim 1, further comprising a tine support, said tine support being attached to said tine and extending adjacent said tine, wherein said tine support extends along only a portion of a length of said tine.

9. The large bale handler according to claim 1, wherein said tractor connection comprises a first plate, a second plate, and a third plate thereby forming three plates extending parallel to each other, wherein a first space is formed between said first plate and said second plate adapted for a category 2 hitch, and wherein a second space is formed between said second plate and said third plate adapted for a category 3 hitch.

10. The large bale handler according to claim 1, wherein said three plates extend forward from a support beam of said tractor connection, wherein said first space and said second space extend downward thereby being adapted to be connected to a quick-attach hitch.

11. The large bale handler according to claim 1, wherein said tractor connection comprises three connection points adapted to be connected to a three-point hitch on a rear of said tractor, and further comprising at least two of said tines; wherein said tines extend more than 6.5 feet from said tractor connection; wherein each of said two large bales weighs about 1,000 pounds; and wherein said tines are attached to a bottom of said tractor connection, each of said two large bales thereby being loadable by sliding said tines below each of said two large bales along a ground surface.

12. The large bale handler according to claim 11, wherein said tines extend at least 9 feet from said tractor connection; and further comprising tine supports, one of said tine supports being attached to each of said tines and extending adjacent said tines, wherein said tine supports extend along only a portion of a length of said tines.

13. The large bale handler according to claim 12, wherein said tines extend about 10 feet from said tractor connection; wherein said tractor connection comprises a first plate, a second plate, and a third plate thereby forming three plates extending parallel to each other, wherein a first space is formed between said first plate and said second plate adapted for a category 2 hitch, and wherein a second space is formed between said second plate and said third plate adapted for a category 3 hitch; and wherein said three plates extend forward from a support beam of said tractor connection, wherein said first space and said second space extend downward thereby being adapted to be connected to a quick-attach hitch.

14. A large bale handler, comprising: a tractor connection, a support beam attached to said tractor connection and extending along a width, two tines attached to opposing ends of said support beam, said two tines extending away from said tractor connection generally parallel to each other, wherein said two tines are adapted to support two large bales oriented in tandem with one of said two large bales behind another of said two large bales.

15. The large bale handler according to claim 14, wherein said tractor connection comprises three connection points adapted to be connected to a three-point hitch on a rear of said tractor; wherein said tines are attached to a bottom of said tractor connection, each of said two large bales thereby being loadable by sliding said tines below each of said two large bales along a ground surface; and wherein said tines extend at least 9 feet from said tractor connection.

16. A large bale handler, comprising: a tractor connection, at least two tines extending from said tractor connection, wherein said two tines extend parallel to each other and further extend more than 6.5 feet from said tractor connection.

17. The large bale handler according to claim 16, wherein said tines extend at least 9 feet from said tractor connection.

18. The large bale handler according to claim 17, further comprising tine supports, one of said tine supports being attached to each of said tines and extending adjacent said tines, wherein said tine supports extend along only a portion of a length of said tines.

19. The large bale handler according to claim 17, wherein said tractor connection comprises three connection points adapted to be attached to a three-point hitch on a rear of said tractor; and wherein said tines are connected to a bottom of said tractor connection, each of said two large bales thereby being loadable by sliding said tines below each of said two large bales along a ground surface.

20. The large bale handler according to claim 19, further comprising tine supports, one of said tine supports being attached to each of said tines and extending adjacent said tines, wherein said tine supports extend along only a portion of a length of said tines.

21. The large bale handler according to claim 19, wherein said tines extend about 10 feet from said tractor connection; and wherein each of said two large bales extends about 5 feet along said tine and each of said two large bales weighs about 1,000 pounds.
